(19) United States
(12) Patent Application Publication
(10) Pub. No.: US 2025/0155885 A1
(43) Pub. Date: May 15, 2025

(54) FAULT DETECTION AND CLASSIFICATION DEVICE, PROCESS MANAGEMENT SYSTEM INCLUDING THE SAME, AND METHOD OF RECOMMENDING OPTIMAL OPERATING RANGE

(71) Applicant: SAMSUNG ELECTRONICS CO., LTD., Suwon-si (KR)

(72) Inventors: Taehyung KIM, Suwon-si (KR); Byeongseop KIM, Suwon-si (KR); Yeonjoong KIM, Suwon-si (KR); Juyeon YUN, Suwon-si (KR); Yoolee LIM, Suwon-si (KR)

(73) Assignee: SAMSUNG ELECTRONICS CO., LTD., Suwon-si (KR)

(21) Appl. No.: 18/751,782

(22) Filed: Jun. 24, 2024

(30) Foreign Application Priority Data
Nov. 14, 2023 (KR) 10-2023-0157702

(51) Int. Cl. G05B 23/02

(52) U.S. Cl. CPC G05B 23/0275; G05B 23/024

(57) ABSTRACT

A process management system includes a fault detection and classification (FDC) module that analyzes a trend of sensor data of an equipment or a facility, classifies the sensor data as a type according to the trend, calculates specification data according to the type, and selects optimal specification data by verifying the specification data, and a user interface module that displays the optimal specification data, a simulation result, and an increase/decrease in an interlock before/after changing to the optimal specification data, and a storage that stores the sensor data, the specification data, and the optimal specification data. The sensor data is state information measured by a sensor mounted on the equipment or the facility, the specification data includes an upper control limit (UCL) and/or a lower control limit (LCL), and when the sensor data exceeds the UCL or the LCL, the interlock is applied to the equipment or the facility.

### CROSS-REFERENCE TO RELATED APPLICATION

This application is based on and claims priority under 35 U.S.C. § 119 to Korean Patent Application No. 10-2023-0157702, filed on Nov. 14, 2023, in the Korean Intellectual Property Office, the disclosure of which being incorporated by reference herein in its entirety.

### BACKGROUND

Systems, devices, apparatuses, and methods consistent with the present disclosure relate to a fault detection device, and more particularly, to a fault detection and classification (FDC) device for detecting and classifying faults in a semiconductor process, a process management system including the same, and a method of recommending an optimal operating range.

FDC may monitor and analyze sensor data of equipment in real-time in the semiconductor manufacturing industry to detect an abnormality of a process, identify the abnormality that has occurred, and quickly classify basic causes of faults associated with the abnormality, thereby maximizing equipment usage. By doing this classification, a product yield may be improved and a cycle time may be reduced, thereby eventually improving the productivity of a whole factory.

Recently, in the semiconductor manufacturing field, along with the trend of an increase and miniaturization of sensors for generating data, quick transmission and precise analysis of bulk data have been demanded.

### SUMMARY

It is an aspect to provide a fault detection and classification (FDC) device for providing an optimal operating range in a process, a process management system including the same, and a method of recommending the optimal operating range.

According to an aspect of one or more embodiments, there is provided a process management system comprising a processor and a storage which stores computer code which, when executed by the processor, causes the processor to implement at least a fault detection and classification (FDC) module configured to analyze a trend of sensor data of an equipment or a facility, classify the sensor data as a type according to the trend, calculate specification data according to the type of the sensor data, and select optimal specification data by verifying the specification data; a user interface module configured to display the optimal specification data, a simulation result according to the optimal specification data, and an increase/decrease in an interlock before and after changing to the optimal specification data; and a storage configured to store the sensor data classified on a type basis, the specification data, and the optimal specification data, wherein the sensor data is state information measured by at least one sensor mounted on the equipment or the facility, the specification data includes an upper control limit (UCL) and/or a lower control limit (LCL), and when the sensor data exceeds the UCL or the LCL, the interlock is applied to the equipment or the facility.

According to another aspect of one or more embodiments, there is provided a fault detection and classification (FDC) device comprising a processor and a storage which stores computer code which, when executed by the processor, causes the processor to implement at least a classifier configured to analyze a trend of sensor data of an equipment or a facility and classify the sensor data as a type according to the trend; a calculator configured to calculate specification data according to the type of the sensor data; and a verifier configured to verify the specification data by simulating the specification data before the specification data is set for the equipment or the facility, wherein the sensor data is state information measured by at least one sensor mounted on the equipment or the facility, the specification data includes an upper control limit (UCL) and/or a lower control limit (LCL), and when the sensor data exceeds the UCL or the LCL, an interlock is applied to the equipment or the facility.

According to another aspect of one or more embodiments, there is provided a method of recommending an optimal operating range, the method comprising collecting sensor data measured by at least one sensor mounted on an equipment or a facility; determining whether a number of interlock occurrences of the equipment or the facility exceeds a threshold number for a certain period of time or whether an operating range of the at least one sensor for application of an interlock exceeds a threshold sigma level; based on the determining, analyzing a trend of the sensor data and classifying the sensor data as a type according to the trend; calculating specification data according to the type of the sensor data; verifying the specification data by simulating the specification data before the specification data is set for the equipment or the facility; and displaying a simulation result according to the specification data and an increase/decrease in the interlock before and after changing to the specification data, wherein the sensor data is state information measured by the at least one sensor mounted on the equipment or the facility, the specification data includes an upper control limit (UCL) and/or a lower control limit (LCL), and when the sensor data exceeds the UCL or the LCL, the interlock is applied to the equipment or the facility.

### BRIEF DESCRIPTION OF THE DRAWINGS

Various embodiments will be more clearly understood from the following detailed description taken in conjunction with the accompanying drawings, in which:

FIG. 1 is a block diagram schematically illustrating a process management system according to an embodiment;

FIG. 2 is a block diagram schematically illustrating a monitoring module of the process management system of FIG. 1, according to an embodiment;

FIG. 3 is a block diagram schematically illustrating a fault detection and classification (FDC) module of the process management system of FIG. 1, according to an embodiment;

FIG. 4 is a block diagram schematically illustrating a user interface (UI) module of the process management system of FIG. 1, according to an embodiment;

FIG. 5A is a graph illustrating target-type sensor data, according to an embodiment;

FIG. 5B is a graph illustrating drift-type sensor data, according to an embodiment;

FIG. 5C is a graph illustrating shift-type sensor data, according to an embodiment;

FIG. 5D is a graph illustrating constant-type sensor data, according to an embodiment;

FIG. 5E is a graph illustrating multi-line-type sensor data, according to an embodiment;

FIG. 5F is a graph illustrating distribution-type sensor data, according to an embodiment;

FIG. 6 is a heat map according to a grid search, according to an embodiment;

FIG. 7 shows screens indicating simulation results, according to an embodiment; and

FIG. 8 is a flowchart schematically illustrating a method of recommending an optimal operating range, according to an embodiment.

### DETAILED DESCRIPTION

Hereinafter, various embodiments are described in detail with reference to the accompanying drawings. Like reference numerals in the drawings denote like elements, and thus their repetitive description will be omitted for conciseness.

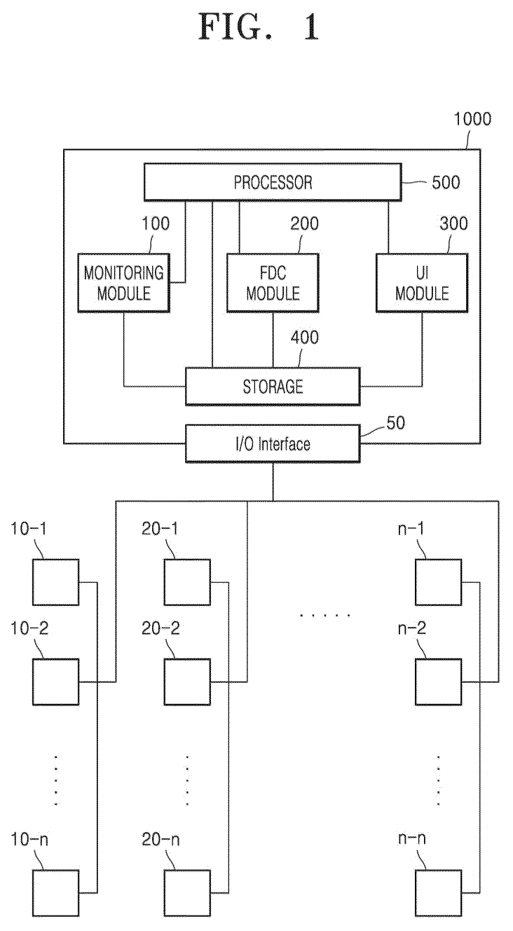

FIG. 1 is a block diagram schematically illustrating a process management system 1000 according to an embodiment.

Referring to FIG. 1, the process management system 1000 according to an embodiment may include an input/output interface 50, which may be communicably connected to a plurality of pieces of process equipment 10-1, 10-2, . . . , 10-n, 20-1, 20-2, . . . , 20-n, . . . , n-1, n-2, . . . , n-n, and by which a user who manages a process may monitor the state of each of the plurality of pieces of process equipment 10-1, 10-2, . . . , 10-n, 20-1, 20-2, . . . , 20-n, . . . , n-1, n-2, . . . , n-n and adjust process conditions of the plurality of pieces of process equipment 10-1, 10-2, . . . , 10-n, 20-1, 20-2, . . . , 20-n, . . . , n-1, n-2, . . . , n-n, and a storage capable of storing data, such as process variables, acquired from the plurality of pieces of process equipment 10-1, 10-2, . . . , 10-n, 20-1, 20-2, . . . , 20-n, . . . , n-1, n-2, . . . , n-n, and the like. Herein, each of the plurality of pieces of process equipment 10-1, 10-2, . . . , 10-n, 20-1, 20-2, . . . , 20-n, . . . , n-1, n-2, . . . , n-n may be equipment or a facility for semiconductor manufacturing.

For example, in an embodiment, each of the plurality of pieces of process equipment 10-1, 10-2, . . . , 10-n, 20-1, 20-2, . . . , 20-n, . . . , n-1, n-2, . . . , n-n may include a sensor configured to measure a process status. Sensor data measured by the sensor may be transmitted to the process management system 1000. The process management system 1000 may analyze the sensor data and, if a change greater than or equal to a reference value occurs in the sensor data, adjust an operation of each of the plurality of pieces of process equipment 10-1, 10-2, . . . , 10-n, 20-1, 20-2, . . . , 20-n, . . . , n-1, n-2, . . . , n-n. For example, if the sensor data exceeds a process criterion, the process management system 1000 may enable an interlock for stopping an operation of each of the plurality of pieces of process equipment 10-1, 10-2, . . . , 10-n, 20-1, 20-2, . . . , 20-n, . . . , n-1, n-2, . . . , n-n.

The plurality of pieces of process equipment 10-1, 10-2, . . . , 10-n, 20-1, 20-2, . . . , 20-n, . . . , n-1, n-2, . . . , n-n may be controlled based on a certain process variable, and the process variable may be controlled by the process management system 1000. The process variable may include a parameter for controlling each semiconductor process, sensor data sensed by a fault detection and classification (FDC) sensor or an optical emission spectroscopy (OES) sensor, or the like.

For example, a photo process may include coating a wafer with a photoresist (PR) material and baking the wafer at a high temperature, wherein a baking temperature, a PR coating speed in spin coating for coating the PR material, and the like, may be process variables influencing the yield of the wafer. As a particular example, the PR coating speed may be represented by revolutions per minute (RPM). The process management system 1000 may select a baking temperature, a PR coating speed, and the like, as process variables for process equipment configured to apply a photo process to a wafer. For process equipment configured to apply a deposition process to a wafer, a gas flow rate, a chuck temperature, a chamber temperature, or the like for deposition may be a process variable. In an embodiment, the chuck temperature is the temperature of a chuck on which a wafer is loaded and may be measured by a chuck temperature measurement jig.

The process management system 1000 may acquire statistical data of a corresponding process variable with respect to process variables selected for each of the plurality of pieces of process equipment 10-1, 10-2, . . . , 10-n, 20-1, 20-2, . . . , 20-n, . . . , n-1, n-2, . . . , n-n. For example, if a total number of wafers produced by being introduced to a process is m, baking temperatures applied to the m wafers may be collected, and statistical data of a process variable that is a baking temperature may be acquired using a mean value, a measure of dispersion, and the like of the collected baking temperatures. The process management system 1000 may also acquire statistical data of other process variables, such as a PR coating speed, OES data generated during an etch process, and a film coating speed for controlling a film coating process, in a similar manner.

The process management system 1000 according to an embodiment may include, for example, a monitoring module 100, an FDC module 200, a user interface (UI) module 300, a storage 400 that stores data and program code for implementing the monitoring module, the FDC module 200 and the UI module 300, and a processor 500 which accesses the storage 400 and executes the program code to cause the processor 500 to perform the functions of the monitoring module 100, the FDC module 200 and the UI module 300 described in more detail below. In an embodiment, the processor 500 may be a microprocessor, a microcontroller, an application specific integrated circuit (ASIC), or a central processing unit (CPU). In an embodiment, the processor 500 may include a plurality of processors. In a configuration with a plurality of processors, each of the monitoring module 100, the FDC module 200 and the UI module 300 may be implemented by an corresponding processor of the plurality of processors. In an embodiment, the monitoring module 100, the FDC module 200 and the UI module 300 may be implemented by the plurality of processors together. In some embodiments, the process management system 1000 may include hardware control logic coded to implement the monitoring module, the FDC module 200 and the UI module 300. In this case, the process management system 1000 may omit the processor 500, and the storage 400 may store only data.

The monitoring module 100 may monitor a process variable of equipment or a facility. In particular, the monitoring module 100 may monitor whether an interlock occurs. Herein, “Interlock” means preventing or stopping an operation of equipment or a facility under a particular condition. A process interlock may control the quality of a product by stopping an operation if a preset process criterion is not satisfied, where the preset processor criterion ensures that an optimal product is produced. That is, if the process criterion is not satisfied, an operation may be stopped until the process criterion is satisfied, such that the defect rate of a product is minimized. The monitoring module 100 may acquire sensor data measured by the sensors of the plurality of pieces of process equipment 10-1, 10-2, . . . , 10-n, 20-1, 20-2, . . . , 20-n, . . . , n-1, n-2, . . . , n-n or the facility and monitor whether the interlock occurs due to the sensor data exceeding the process criterion.

The monitoring module 100 may determine whether the number of interlock occurrences of the plurality of pieces of process equipment 10-1, 10-2, . . . , 10-n, 20-1, 20-2, . . . , 20-n, . . . , n-1, n-2, . . . , n-n or the facility exceeds a threshold number for a certain period of time or whether the operating range of the sensor for application of the interlock exceeds a threshold sigma level.

If the number of interlock occurrences of the equipment or the facility exceeds the threshold number for the certain period of time or whether the operating range of the sensor for the application of the interlock exceeds the threshold sigma level, the FDC module 200 may operate. If the number of interlock occurrences of the equipment or the facility does not exceed the threshold number for the certain period of time or if the operating range of the sensor for interlock application does not exceed the threshold sigma level, the FDC module 200 does not operate and the monitoring module 100 may continuously monitor the equipment or the facility.

For example, if the monitoring module 100 determines that the interlock occurs more than five times per month or a sigma level exceeds a three-sigma level, the FDC module 200 may operate to calculate specification data and optimal specification data. Otherwise, if the monitoring module 100 determines that interlock occurs five or less times per month or the sigma level is less than or equal to the three-sigma level, the FDC module 200 may neither operate nor calculate the specification data and the optimal specification data.

The FDC module 200 may operate when the number of interlock occurrences of the equipment or the facility exceeds the threshold number for the certain period of time or when the operating range of the sensor for the application of the interlock exceeds the threshold sigma level, because progressing a process up to a sigma level corresponding to an allowable defect ratio or less without stopping is advantageous in terms of productivity even though the sensor data may temporarily exceed a reference value or even though a pseudo-interlock may occur.

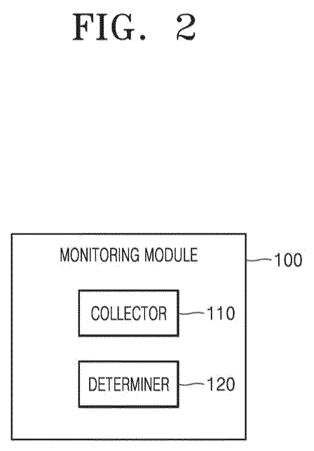

FIG. 2 is a block diagram schematically illustrating the monitoring module 100, according to an embodiment.

Referring to FIG. 2, the monitoring module 100 may include, for example, a collector 110 and a determiner 120. In an embodiment, the storage 400 of FIG. 1 may store program code which, when accessed and executed by the processor 500, causes the processor to implement the collector 110 and the determiner 120. In an embodiment, the hardware control logic may be coded to implement the collector 110 and the determiner 120.

The collector 110 may collect sensor data of equipment or a facility. For example, the collector 110 may be communicably connected to the plurality of pieces of process equipment 10-1, 10-2, . . . , 10-n, 20-1, 20-2, . . . , 20-n, . . . , n-1, n-2, . . . , n-n. The collector 110 may acquire sensor data measured by the sensor mounted on each of the plurality of pieces of process equipment 10-1, 10-2, . . . , 10-n, 20-1, 20-2, . . . , 20-n, . . . , n-1, n-2, . . . , n-n.

The determiner 120 may determine whether the number of interlock occurrences exceeds the threshold number for the certain period of time and whether the operating range of the sensor for the application of the interlock exceeds the threshold sigma level.

If the determiner 120 determines that the number of interlock occurrences of the equipment or the facility exceeds the threshold number for the certain period of time or whether the operating range of the sensor for the application of the interlock exceeds the threshold sigma level, the FDC module 200 may operate. Otherwise, if the determiner 120 determines that the number of interlock occurrences of the equipment or the facility does not exceed the application of the interlock number for the certain period of time or if the operating range of the sensor for the application of the interlock does not exceed the threshold sigma level, the FDC module 200 does not operate and the monitoring module 100 may continuously monitor the equipment or the facility.

Returning to FIG. 1, the FDC module 200 may analyze a trend of the sensor data of the equipment or the facility, classify the sensor data on a type basis according to the trend, calculate specification data according to the type of the sensor data, and select optimal specification data by verifying the specification data.

The sensor data is state information measured by at least one sensor mounted on the equipment or the facility. The specification data corresponds to a kind of the process criterion and may include an upper control limit (UCL) and/or a lower control limit (LCL). If the sensor data exceeds the UCL or the LCL, the interlock may be executed for the equipment or the facility.

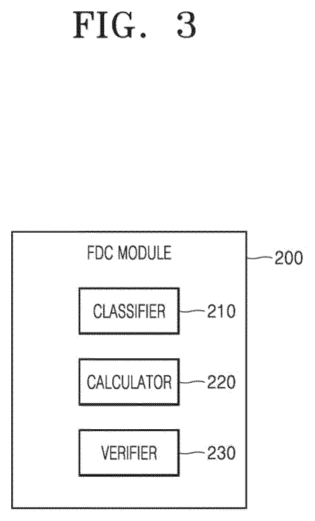

FIG. 3 is a block diagram schematically illustrating the FDC module 200 of FIG. 1.

Referring to FIG. 3, the FDC module 200 may include a classifier 210, a calculator 220, and a verifier 230. In an embodiment, the storage 400 of FIG. 1 may store program code which, when accessed and executed by the processor 500, causes the processor to implement the classifier 210, the calculator 220, and the verifier 230. In an embodiment, the hardware control logic may be coded to implement the classifier 210, the calculator 220 and the verifier 230.

The classifier 210 may analyze the trend of the sensor data and classify the sensor data on the type basis according to the trend. In general, sensor data may be a normal distribution type. When the sensor data is the normal distribution type, a process criterion for the sensor data may be managed with consistency by sigma management only. However, in sensors mounted on pieces of equipment or facilities, sensor data may not be of the normal distribution type but may be various non-normal distribution types according to objects to be measured. For example, sensor data may vary with time or may vary according to a dispersion. In this case, process criterion management with consistency cannot be achieved by sigma management only.

The classifier 210 may classify sensor data as a target type, a drift type, or a shift type according to a change in the sensor data with time and as a constant type, a multi-line type, or a distribution type according to dispersion of the sensor data.

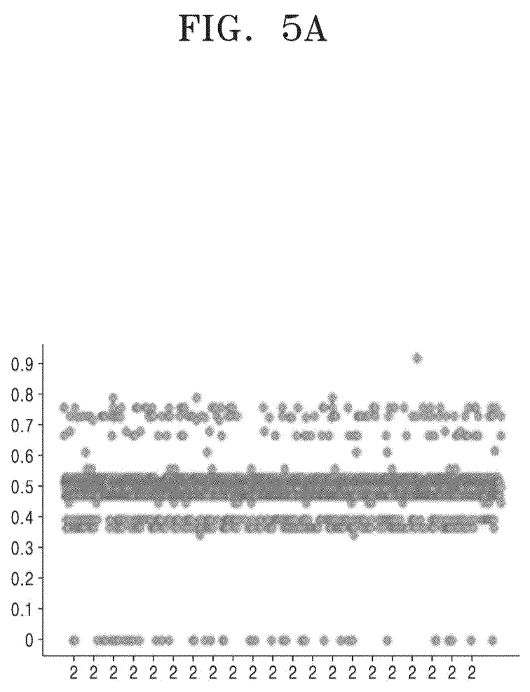

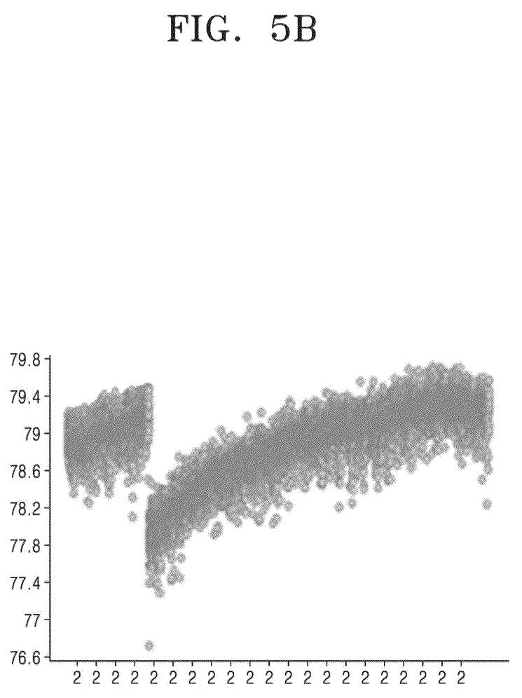

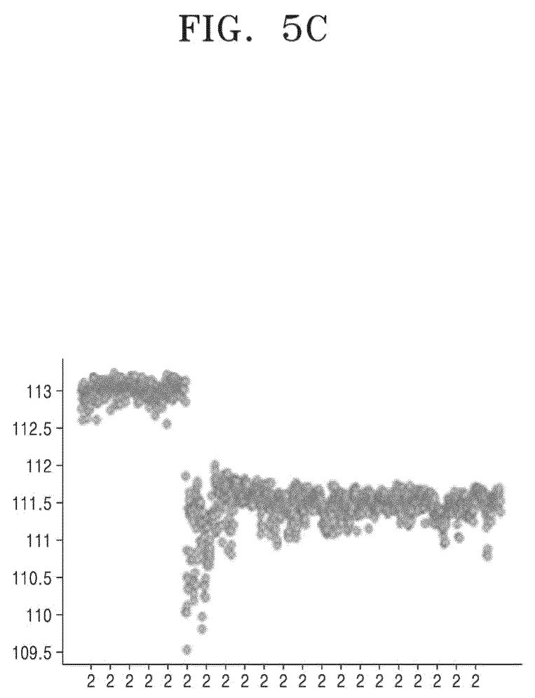

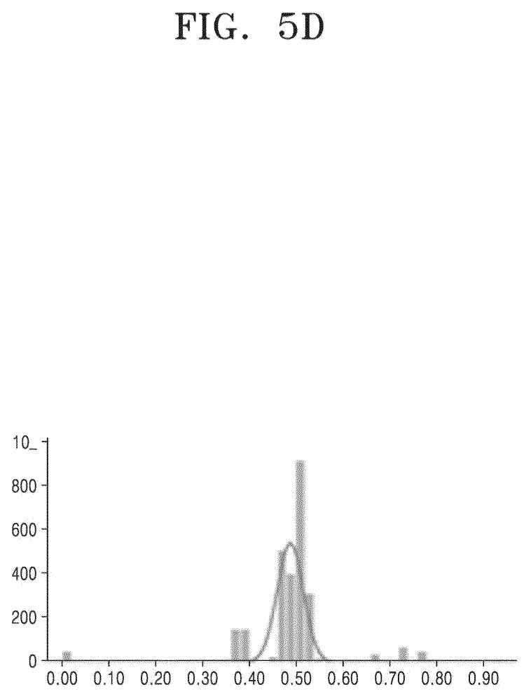

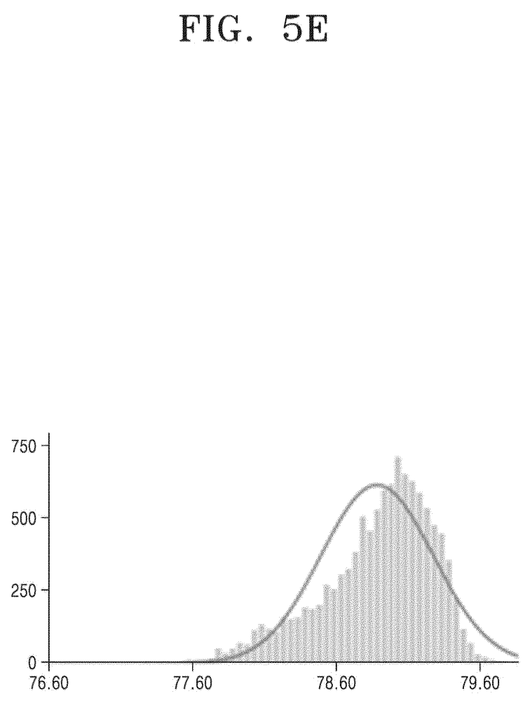

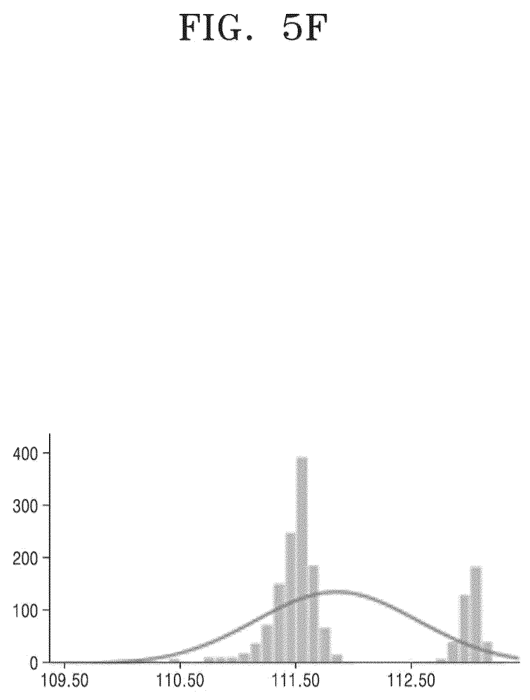

FIGS. 5A to 5C are graphs illustrating sensor data over time on a type basis, according to some embodiments. FIG. 5A is a graph illustrating target-type sensor data, FIG. 5B is a graph illustrating drift-type sensor data, and FIG. 5C is a graph illustrating shift-type sensor data.

Referring to FIG. 5A, the sensor data may have a constant value without ascending or descending to the right with time. As shown in FIG. 5A, when sensor data has a substantially constant value over time, the classifier 210 may classify the sensor data as the target type.

Referring to FIG. 5B, when the sensor data ascends to the right over time, the classifier 210 may classify the sensor data as the drift type. Unlike FIG. 5B, even when sensor data descends to the right over time, the classifier 210 may classify the sensor data as the drift type. In other words, the drift may be ascending or descending.

As a reference, in case of preventive maintenance, sensor data may be discontinuously shown as in FIG. 5B.

Referring to FIG. 5C, when the sensor data discontinuously changes over time, the classifier 210 may classify the sensor data as the shift type. The shift type is similar to the drift type in case of preventive maintenance in that sensor data is discontinuous, but the shift type is different from the drift type in that the shift type has a larger gap between discontinuous sensor data than the drift type, and the drift type tends to ascend or descend to the right even in data before and after the preventive maintenance.

FIGS. 5D to 5F are graphs illustrating sensor data according to dispersion types of the sensor data, according to some embodiments. FIG. 5D is a graph illustrating constant-type sensor data, FIG. 5E is a graph illustrating multi-line-type sensor data, and FIG. 5F is a graph illustrating distribution-type sensor data.

Referring to FIG. 5D, the constant type may be a type of sensor data having a constant value. The constant type may include not only a case where sensor data has a particular one value but also a case where sensor data has various values but concentrates on a particular value.

The distribution type may be a type of sensor data of which the dispersion has a tail. The distribution type may include a zero-tail type, a one-tail type, and a two-tail type according to the numbers of tails. The zero-tail type may be a case where there are no tails at both sides of a mode, the one-tail type may be a case where there is a tail at one side of the mode, and the two-tail type may be a case where there are tails at both sides of the mode. FIG. 5E shows the two-tail type having tails at both sides of the mode.

The multi-line type may be a type of sensor data having a plurality of constant values. As shown in FIG. 5F, when sensor data has two peaks separated from each other, the sensor data may correspond to the multi-line type.

TABLE 1

| Type | | Target type | Drift type | Shift type |
|---|---|---|---|---|
| Constant type | | CT | CD | CS |
| Multi-line type | | MT | MD | MS |
| Distribution | Zero tail | DT0 | DD0 | DS0 |
| type | One tail | DT1 | DD1 | DS1 |
| | Two tails | DT2 | DD2 | DS2 |

As shown in Table 1, the classifier 210 may classify sensor data as 15 types by using a change over time as one axis and a dispersion of the sensor data as the other axis. For example, if sensor data is the target type in a type of a change over time and is a constant type in a type of a change in dispersion, the classifier 210 may classify the sensor data as CT.

The calculator 220 may calculate specification data according to a type of sensor data. The specification data may include a UCL and/or an LCL.

The calculator 220 may calculate the UCL by using Equation (1) below

$$UCL = \hat{μ} + t \times e \times \sqrt{{σ}_{b}^{2} + \frac{{σ}_{w}^{2}}{p}} \times ( 1 + s + k ) \qquad Equation ( 1 )$$

and calculate the LCL by using Equation (2) below:

$$LCL = \hat{μ} - t \times e \times \sqrt{{σ}_{b}^{2} + \frac{{σ}_{w}^{2}}{p}} \times ( 1 - s + k ) , \qquad Equation ( 2 )$$

where û denotes a mean of sensor data, t denotes correction according to a type of the sensor data, e denotes a sensor-specific management criterion, σ_{b} denotes sigma b, σ_{w} denotes sigma w, p denotes a p value, s denotes a skewness correction value, and k denotes a kurtosis correction value.

The calculator 220 may use a value of 1 for t if the type of sensor data classified by the classifier 210 is the target type and may use a value of 0.5 for t if the type of the sensor data is the drift type or the shift type.

The calculator 220 may calculate specification data according to the drift type if the drift type exceeds 50% among types of sensor data of the same type of equipment or facility and may calculate specification data according to the shift type if the shift type exceeds 50% among the types of the sensor data. The calculator 220 may calculate specification data according to the target type if the drift type is less than or equal to 50% and the shift type is less than or equal to 50% among the types of the sensor data of the same type of equipment or facility.

If the sensors mounted on a plurality of pieces of equipment or facilities of the same type measure the same object to be measured, sensor data measured by the sensors may be the same type of sensor data. However, according to states of the plurality of pieces of equipment or facilities, the sensor data may be classified as different types of sensor data even though the sensors measure the same object to be measured. In this case, the calculator 220 may calculate specification data with reference to a sensor data type having a proportion exceeding 50% among a plurality of sensor data types.

That is, if the proportion of drift-type sensor data exceeds 50%, the calculator 220 may calculate specification data as the drift type, and if the proportion of shift-type sensor data exceeds 50%, the calculator 220 may calculate specification data as the shift type. If the drift type is less than or equal to 50% and the shift type is less than or equal to 50%, the calculator 220 may calculate specification data as the target type.

The calculator 220 may use a grid search to calculate relatively optimized specification data after calculating specification data by using Equations (1) and (2) according to the type classified by the classifier 210. That is, the calculator 220 may calculate optimal specification data by performing a grid search on the calculated specification data.

A grid search is a technique used for hyperparameter tuning in the machine learning and data science field and is a method of attempting all possible hyperparameter combinations to optimize the performance of a model.

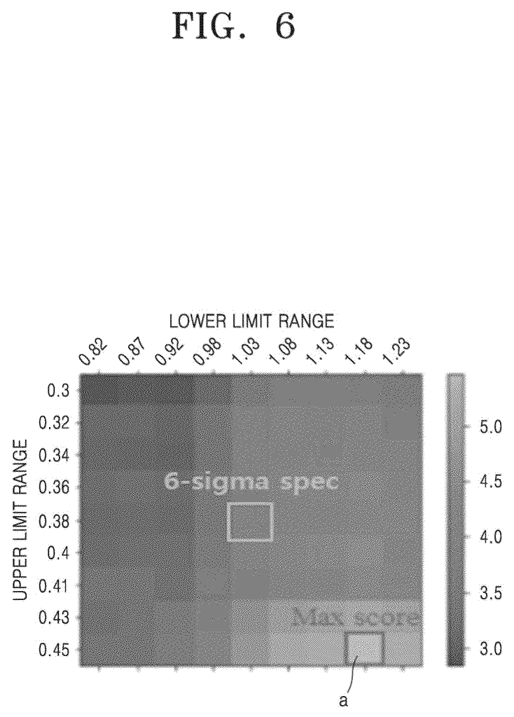

FIG. 6 is a heat map according to a grid search, according to an embodiment.

Referring to FIG. 6, the calculator 220 may derive optimal specification data “a” by combining a possible upper limit range with a possible lower limit range and performing a grid search.

Before the specification data calculated by the calculator 220 is actually set for the equipment or the facility, the verifier 230 may simulate the specification data to verify the specification data. That is, in an embodiment, the verifier 230 may predict an increase/decrease in interlock or a change in a sigma level of the equipment or the facility by simulation before the specification data is applied. In an embodiment, the verifier 230 may predict the increase/decrease in interlock or the change in the sigma level of the equipment or the facility by simulation before and after the specification data is applied.

In an embodiment, the FDC module 200 may be implemented as a separate FDC device. Similar to the FDC module 200, the FDC device may include the classifier 210, the calculator 220, and the verifier 230. In this configuration, in an embodiment, the FDC device may include a processor and a memory, separate from the processor 500 and the storage 400. The memory may store program code for implementing the classifier 210, the calculator 220 and the verifier 230. The processpor may access the memory and execute the program code to cause the processor to implement the classifier 210, the calculator 220 and the verifier 230. In an embodiment, the FDC device may include hardware control logic, separate from the processor 500 or the hardware control logic of the process management system 1000, coded to implement the classifier 210, the calculator 220 and the verifier 230.

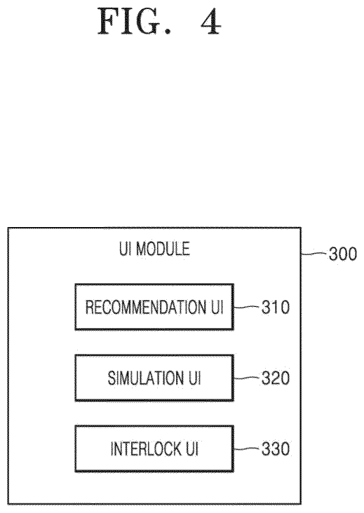

FIG. 4 is a block diagram schematically illustrating the UI module 300 of FIG. 1.

Referring to FIG. 4, the UI module 300 may display optimal specification data, a simulation result according to the optimal specification data, and an increase/decrease in interlock before and after changing to the optimal specification data such that a worker may identify the same.

The UI module 300 may include a recommendation UI 310 configured to display the calculated specification data and the optimal specification data, a simulation UI 320 configured to display the simulation result according to the optimal specification data, and an interlock UI 330 configured to display the increase/decrease in interlock before and after applying the optimal specification data. In an embodiment, the storage 400 of FIG. 1 may store program code which, when accessed and executed by the processor 500, causes the processor to implement the recommendation UI 310, the simulation UI 320, and the interlock UI 330. In an embodiment, the hardware control logic may be coded to implement the recommendation UI 310, the simulation UI 320, and the interlock UI 330.

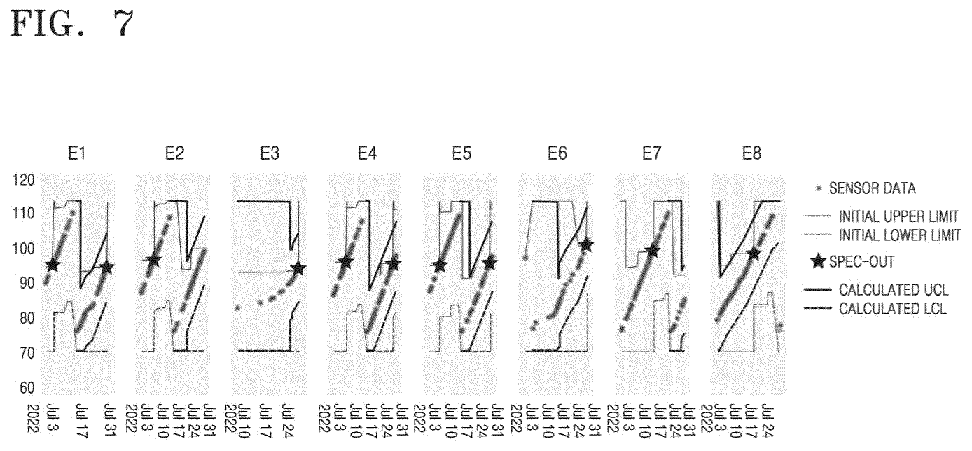

FIG. 7 is a graph showing a simulation result by the verifier 230, which is displayed by the UI module 300, according to an embodiment. In detail, FIG. 7 shows sensor data measured by sensors mounted on eight pieces of equipment of the same type (indicated by E1 to E8 in FIG. 7), initially set upper and lower limits, and a calculated UCL and LCL. Referring to FIG. 7, a spec-out case where the sensor data exceeds the upper or lower limit set by a worker according to a manual in an existing scheme occurs with respect to all of the eight pieces of equipment. According to circumstances, spec-out occurs twice with respect to first, fourth, and fifth pieces of equipment E1, E4, and E5.

However, according to the calculated UCL and LCL, there does not occur a case where sensor data exceeds the UCL or the LCL for any of the pieces of equipment E1-E8.

In this manner, according to an embodiment, as shown in FIG. 7, an increase/decrease in interlock before and after applying calculated specification data may be checked by performing simulation before the calculated specification data is applied to equipment.

The storage 400 may store the sensor data classified on a type basis, specification data, and optimal specification data. That is, the sensor data classified by the classifier 210, the specification data calculated by the calculator 220, and the optimal specification data may be stored in the storage 400. A result simulated by the verifier 230 may also be stored in the storage 400. The UI module 300 may be connected to the storage 400 and may display the sensor data, the specification data, the optimal specification data, and the simulation result stored in the storage 400.

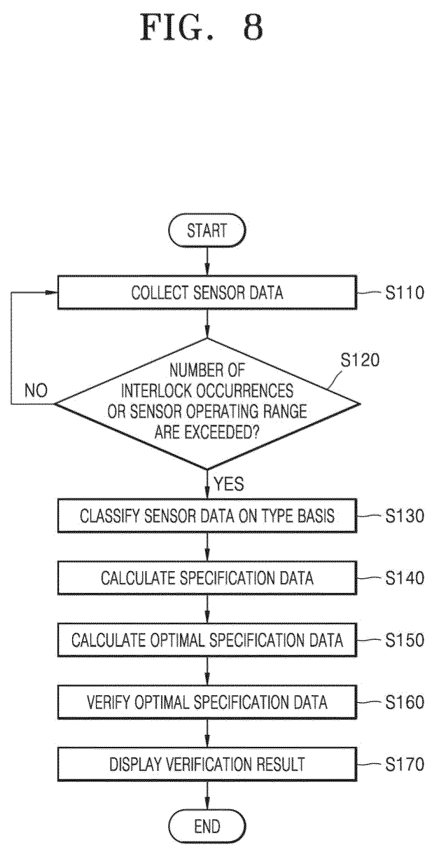

FIG. 8 is a flowchart schematically illustrating a method of recommending an optimal operating range, according to an embodiment. The method of recommending an optimal operating range, which is described with reference to FIG. 8, may be executed by the processor 500 of the process management system 1000 for managing a plurality of pieces of equipment or facilities. In an embodiment, the method of recommending an optimal operating range, according to the embodiment of FIG. 8, may be provided in a form of software stored in a computer-readable recording medium and executed by the process management system 1000 provided as a computer device.

Referring to FIG. 8, the method of recommending an optimal operating range, according to an embodiment, may include operation S110 of collecting sensor data measured by a sensor mounted on an equipment or a facility.

As described above, the collector 110 may be communicably connected to the plurality of pieces of process equipment 10-1, 10-2, . . . , 10-n, 20-1, 20-2, . . . , 20-n, . . . , n-1, n-2, . . . , n-n to acquire sensor data measured by sensors mounted on the plurality of pieces of process equipment 10-1, 10-2, . . . , 10-n, 20-1, 20-2, . . . , 20-n, . . . , n-1, n-2, . . . , n-n.

Thereafter, in operation S120, the determiner 120 may determine whether a number of interlock occurrences exceeds a threshold number for the certain period of time and whether the operating range of the sensor for application of the interlock exceeds the threshold sigma level.

If the determiner 120 determines that the number of interlock occurrences of the equipment or the facility exceeds the threshold number for the certain period of time or that the operating range of the sensor for the application of the interlock exceeds the threshold sigma level (operation S120, YES), the classifier 210 may analyze the trend of the sensor data and classify the sensor data on a type basis according to the trend in operation S130.

Otherwise, if the determiner 120 determines that the number of interlock occurrences of the equipment or the facility does not exceed the certain number for the certain period or that the operating range of the sensor for interlock application does not exceed the certain sigma level (operation S120, NO), the FDC module 200 does not operate and the monitoring module 100 may continuously monitor the equipment or the facility.

After the sensor data is classified on a type basis, the calculator 220 may calculate specification data according to the type of the sensor data in operation S140. The calculator 220 may calculate the UCL and/or the LCL according to Equations (1) and (2).

Thereafter, the calculator 220 may calculate optimal specification data by applying grid search to the calculated specification data in operation S150.

Thereafter, before the specification data calculated by the calculator 220 is actually set for the equipment or the facility, the verifier 230 may simulate the specification data to verify the specification data in operation S160.

In operation S170, the UI module 300 may display the optimal specification data, a simulation result according to the optimal specification data, and an increase/decrease in interlock before and after changing to the optimal specification data such that a worker identifies the same. In some embodiments, thereafter the process management system 1000 may set the specification data for the equipment or the facility.

While various embodiments have been particularly shown and described with reference to the drawings, it will be understood that various changes in form and details may be made therein without departing from the spirit and scope of the following claims.

What is claimed is:

1. A process management system comprising:
a processor and a storage which stores computer code which, when executed by the processor, causes the processor to implement at least:
a fault detection and classification (FDC) module configured to analyze a trend of sensor data of an equipment or a facility, classify the sensor data as a type according to the trend, calculate specification data according to the type of the sensor data, and select optimal specification data by verifying the specification data; and
a user interface module configured to display the optimal specification data, a simulation result according to the optimal specification data, and an increase/decrease in an interlock before and after changing to the optimal specification data; and
a storage configured to store the sensor data classified on a type basis, the specification data, and the optimal specification data,
wherein the sensor data is state information measured by at least one sensor mounted on the equipment or the facility, the specification data includes an upper control limit (UCL) and/or a lower control limit (LCL), and when the sensor data exceeds the UCL or the LCL, the interlock is applied to the equipment or the facility.

2. The process management system of claim 1, wherein the FDC module comprises:
a classifier configured to analyze the trend of the sensor data and classify the sensor data as the type according to the trend;
a calculator configured to calculate the specification data according to the type of the sensor data; and
a verifier configured to verify the specification data by simulating the specification data before the specification data is set for the equipment or the facility.

3. The process management system of claim 2, wherein the type of the sensor data comprises a target type, a drift type, a shift type, a constant type, a multi-line type, and a distribution type,
the classifier is further configured to classify the sensor data as the target type, the drift type, or the shift type according to a change in the sensor data over time and classify the sensor data as the constant type, the multi-line type, or the distribution type according to a dispersion of the sensor data,
wherein the target type is sensor data having a substantially constant value over time, the drift type is sensor data having a value ascending or descending over time, the shift type is sensor data having a value discontinuously changing over time, the constant type is sensor data having a constant value, the multi-line type is sensor data having a plurality of constant values, and the distribution type is sensor data having dispersion with a tail.

4. The process management system of claim 3, wherein the specification data includes the UCL and the LCL, and
the calculator is further configured to calculate the UCL by using Equation (1) below:
$$UCL = \hat{μ} + t \times e \times \sqrt{{σ}_{b}^{2} + \frac{{σ}_{w}^{2}}{p}} \times ( 1 + s + k ) \qquad Equation ( 1 )$$
and calculate the LCL by using Equation (2) below
$$LCL = \hat{μ} - t \times e \times \sqrt{{σ}_{b}^{2} + \frac{{σ}_{w}^{2}}{p}} \times ( 1 - s + k ) , \qquad Equation ( 2 )$$
where û denotes a mean of the sensor data, t denotes correction according to the type, e denotes a sensor-specific management criterion, σ_{b} denotes sigma b, σ_{w} denotes sigma w, p denotes a p value, s denotes a skewness correction value, and k denotes a kurtosis correction value.

5. The process management system of claim 4, wherein the calculator is further configured to:
calculate the specification data according to the drift type when the drift type exceeds 50% among types of the sensor data of a same type of the equipment or the facility,
calculate the specification data according to the shift type when the shift type exceeds 50% among the types of the sensor data, and
calculate the specification data according to the target type when the drift type is less than or equal to 50% and the shift type is less than or equal to 50% among the types of the sensor data.

6. The process management system of claim 4, wherein the calculator is further configured to obtain the optimal specification data for the specification data by performing a grid search.

7. The process management system of claim 2, wherein the verifier is further configured to obtain the increase/decrease in the interlock or a change in a sigma level of the equipment or the facility by simulation before and after the specification data is applied.

8. The process management system of claim 1, wherein the user interface module comprises:
a recommendation user interface configured to display the calculated specification data and the optimal specification data;
a simulation user interface configured to display the simulation result according to the optimal specification data; and
an interlock user interface configured to display the increase/decrease in the interlock before and after the optimal specification data is applied.

9. The process management system of claim 1, further comprising a monitoring module configured to monitor whether the interlock occurs in the equipment or the facility,
wherein the FDC module operates when a number of interlock occurrences exceeds a threshold number for a certain period of time or when an operating range of the at least one sensor for application of the interlock exceeds a threshold sigma level.

10. The process management system of claim 9, wherein the monitoring module comprises:
a collector configured to collect the sensor data of the equipment or the facility; and
a determiner configured to determine whether the number of interlock occurrences monitored by the monitoring module exceeds the threshold number for the certain period of time or whether the operating range of the at least one sensor for the application of the interlock exceeds the threshold sigma level.

11. A fault detection and classification (FDC) device comprising a processor and a storage which stores computer code which, when executed by the processor, causes the processor to implement at least:
a classifier configured to analyze a trend of sensor data of an equipment or a facility and classify the sensor data as a type according to the trend;
a calculator configured to calculate specification data according to the type of the sensor data; and
a verifier configured to verify the specification data by simulating the specification data before the specification data is set for the equipment or the facility,
wherein the sensor data is state information measured by at least one sensor mounted on the equipment or the facility, the specification data includes an upper control limit (UCL) and/or a lower control limit (LCL), and when the sensor data exceeds the UCL or the LCL, an interlock is applied to the equipment or the facility.

12. The FDC device of claim 11, wherein the type of the sensor data comprises a target type, a drift type, a shift type, a constant type, a multi-line type, and a distribution type,
the classifier is further configured to classify the sensor data as the target type, the drift type, or the shift type according to a change in the sensor data over time and classify the sensor data as the constant type, the multi-line type, or the distribution type according to a dispersion of the sensor data,
wherein the target type is sensor data having a substantially constant value over time, the drift type is sensor data having a value ascending or descending over time, the shift type is sensor data having a value discontinuously changing over time, the constant type is sensor data having a constant value, the multi-line type is sensor data having a plurality of constant values, and the distribution type is sensor data having dispersion with a tail.

13. The FDC device of claim 12, wherein the specification data includes the UCL and the LCL, and
the calculator is further configured to calculate the UCL by using Equation (1) below
$$UCL = \hat{μ} + t \times e \times \sqrt{{σ}_{b}^{2} + \frac{{σ}_{w}^{2}}{p}} \times ( 1 + s + k ) \qquad Equation ( 1 )$$
and calculate the LCL by using Equation (2) below
$$LCL = \hat{μ} - t \times e \times \sqrt{{σ}_{b}^{2} + \frac{{σ}_{w}^{2}}{p}} \times ( 1 - s + k ) , \qquad Equation ( 2 )$$
where û denotes a mean of the sensor data, t denotes correction according to the type, e denotes a sensor-specific management criterion, σ_{b} denotes sigma b, σ_{w} denotes sigma w, p denotes a p value, s denotes a skewness correction value, and k denotes a kurtosis correction value.

14. The FDC device of claim 11, wherein the calculator is further configured to obtain optimal specification data for the specification data by performing a grid search.

15. The FDC device of claim 14, wherein the calculator is further configured to obtain the optimal specification data for the specification data by performing the grid search by combining a possible upper limit range and a possible lower limit range.

16. A method of recommending an optimal operating range, the method comprising:
collecting sensor data measured by at least one sensor mounted on an equipment or a facility;
determining whether a number of interlock occurrences of the equipment or the facility exceeds a threshold number for a certain period of time or whether an operating range of the at least one sensor for application of an interlock exceeds a threshold sigma level;
based on the determining, analyzing a trend of the sensor data and classifying the sensor data as a type according to the trend;
calculating specification data according to the type of the sensor data;
verifying the specification data by simulating the specification data before the specification data is set for the equipment or the facility; and
displaying a simulation result according to the specification data and an increase/decrease in the interlock before and after changing to the specification data,
wherein the sensor data is state information measured by the at least one sensor mounted on the equipment or the facility, the specification data includes an upper control limit (UCL) and/or a lower control limit (LCL), and when the sensor data exceeds the UCL or the LCL, the interlock is applied to the equipment or the facility.

17. The method of claim 16, wherein, based on determining that the number of interlock occurrences exceeds the threshold number for the certain period of time or determining that the operating range of the at least one sensor for the application of the interlock exceeds the threshold sigma level, the classifying is executed.

18. The method of claim 16, wherein the type of the sensor data comprises a target type, a drift type, a shift type, a constant type, a multi-line type, and a distribution type, and
classifying the sensor data comprises:
classifying the sensor data as the target type, the drift type, or the shift type according to a change in the sensor data over time; and
classifying the sensor data as the constant type, the multi-line type, or the distribution type according to a dispersion of the sensor data,
wherein the target type is sensor data having a substantially constant value over time, the drift type is sensor data having a value ascending or descending over time, the shift type is sensor data having a value discontinuously changing over time, the constant type is sensor data having a constant value, the multi-line type is sensor data having a plurality of constant values, and the distribution type is sensor data having dispersion with a tail.

19. The method of claim 18, wherein the specification data includes the UCL and the LCL, and
the calculating comprises calculating the UCL by using Equation (1) below
$$UCL = \hat{μ} + t \times e \times \sqrt{{σ}_{b}^{2} + \frac{{σ}_{w}^{2}}{p}} \times ( 1 + s + k ) \qquad Equation ( 1 )$$
and calculating the LCL by using Equation (2) below
$$LCL = \hat{μ} - t \times e \times \sqrt{{σ}_{b}^{2} + \frac{{σ}_{w}^{2}}{p}} \times ( 1 - s + k ) , \qquad Equation ( 2 )$$
where û denotes a mean of the sensor data, t denotes correction according to the type, e denotes a sensor-specific management criterion, σ_{b} denotes sigma b, σ_{w} denotes sigma w, p denotes a p value, s denotes a skewness correction value, and k denotes a kurtosis correction value.

20. The method of claim 17, wherein the calculating comprises obtaining optimal specification data for the specification data by performing a grid search.
